(19) United States
(12) Patent Application Publication
(10) Pub. No.: US 2016/0269296 A1
(43) Pub. Date: Sep. 15, 2016

(54) ARRANGING MEDIA ACCESS CONTROL PROTOCOL DATA UNITS IN A WIRELESS TRANSMISSION

(71) Applicant: QUALCOMM Incorporated, San Diego, CA (US)

(72) Inventors: Santosh Paul Abraham, San Diego, CA (US); George Cherian, San Diego, CA (US); Simone Merlin, San Diego, CA (US); Gwendolyn Denise Barriac, Encinitas, CA (US)

(21) Appl. No.: 15/051,960

(22) Filed: Feb. 24, 2016

Related U.S. Application Data
(60) Provisional application No. 62/130,890, filed on Mar. 10, 2015.

(51) Int. Cl. H04L 12/803; H04W 76/04; H04W 72/04; H04W 4/06

(52) U.S. Cl. CPC H04L 47/125; H04W 4/06; H04W 76/046; H04W 72/0453

(57) ABSTRACT

A method for arranging media access control protocol data units (MPDUs) includes generating a multi-destination aggregated media access control protocol data unit (MD-AMPDU) at an access point. The MD-AMPDU includes a first set of one or more MPDUs having a first receive address associated with a first station and a second set of one or more MPDUs having a second receive address associated with a second station. The first set of one or more MPDUs is grouped together in the MD-AMPDU and the second set of one or more MPDUs is grouped together in the MD-AMPDU. The method also includes transmitting the MD-AMPDU to the first station and to the second station via an Institute of Electrical and Electronics Engineers (IEEE) 802.11 wireless network.

### I. CLAIM OF PRIORITY

The present application claims priority from U.S. Provisional Patent Application No. 62/130,890, filed Mar. 10, 2015, entitled “ARRANGING MEDIA ACCESS CONTROL PROTOCOL DATA UNITS IN A WIRELESS TRANSMISSION,” which is incorporated by reference in its entirety.

### II. FIELD

The present disclosure is generally related to wireless transmissions.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

An access point in an Institute of Electrical and Electronics (IEEE) 802.11 wireless network may broadcast physical layer protocol data units (PPDUs) to multiple stations (e.g., wireless telephones) in the IEEE 802.11 wireless network. Each PPDU may include media access control protocol data units (MPDUs) that are addressed to a single station in the IEEE 802.11 wireless network. Thus, for each PPDU broadcast by the access point, other stations in the IEEE 802.11 wireless network may receive a PPDU having data (e.g., MPDUs) addressed to the single station. To illustrate, if the access point broadcasts a PPDU having MPDUs addressed to a first station in the IEEE 802.11 wireless network, a second station and a third station in the IEEE 802.11 wireless network may also receive the PPDU, even though the PPDU does not include MPDUs addressed to the second and third stations.

Thus, the access point may be required to broadcast three PPDUs to each station in order for each station to receive their respective MPDUs. Broadcasting three PPDUs may result in congestion within the IEEE 802.11 wireless network. Additionally, stations may utilize a relatively large amount of power (e.g., battery life) decoding PPDUs having MPDUs addressed to another station.

### IV. SUMMARY

The present disclosure is directed to techniques for arranging media access control protocol data units (MPDUs) in wireless transmissions to reduce wireless network congestion. An access point may sequentially arrange data (e.g., MPDUs) in a wireless transmission (e.g., a multi-destination aggregated MPDU (MD-AMPDU)) such that first data addressed to a first station is grouped together, second data addressed to a second station is grouped together, and third data addressed to a third station is grouped together. Upon receiving the wireless transmission, the first station may enter into a low-power mode after decoding the first data, the second station may enter into a low-power mode after decoding the second data, and the third station may enter into a low-power mode after decoding the third data. By grouping data addressed to a particular station together, after decoding at least a portion of data addressed to the particular station, the particular station may determine to enter into a low-power mode after detecting data addressed to another station. For example, the particular station may determine that there is no more data in the wireless transmission that is addressed to the particular station after detecting data addressed to another station. Additionally, a single wireless transmission may be broadcasted to the stations (as opposed to three separate wireless transmissions) to reduce congestion within a wireless network.

In a particular implementation, a method for arranging media access control protocol data units (MPDUs) in a wireless transmission to reduce power consumption at one or more stations receiving the wireless transmission includes generating a multi-destination aggregated media access control protocol data unit (MD-AMPDU) at an access point. The MD-AMPDU includes a first set of one or more MPDUs having a first receive address associated with a first station and a second set of one or more MPDUs having a second receive address associated with a second station. The first set of one or more MPDUs is grouped together in the MD-AMPDU and the second set of one or more MPDUs is grouped together in the MD-AMPDU. The method also includes transmitting the MD-AMPDU to the first station and to the second station via an Institute of Electrical and Electronics Engineers (IEEE) 802.11 wireless network.

In another particular implementation, an access point includes a processor and a memory storing instructions executable by the processor to perform operations including generating a multi-destination aggregated media access control protocol data unit (MD-AMPDU). The MD-AMPDU includes a first set of one or more media access control protocol data units (MPDUs) having a first receive address associated with a first station and a second set of one or more MPDUs having a second receive address associated with a second station. The first set of one or more MPDUs is grouped together in the MD-AMPDU and the second set of one or more MPDUs is grouped together in the MD-AMPDU. The operations also include initiating transmission of the MD-AMPDU to the first station and to the second station via an Institute of Electrical and Electronics Engineers (IEEE) 802.11 wireless network.

In another particular implementation, a non-transitory computer-readable medium includes instructions for arranging media access control protocol data units (MPDUs) in a wireless transmission to reduce power consumption at one or more stations receiving the wireless transmission. The instructions, when executed by a processor within an access point, cause the processor to generate a multi-destination aggregated media access control protocol data unit (MD-AMPDU). The MD-AMPDU includes a first set of one or more media access control protocol data units (MPDUs) having a first receive address associated with a first station and a second set of one or more MPDUs having a second receive address associated with a second station. The first set of one or more MPDUs is grouped together in the MD-AMPDU and the second set of one or more MPDUs is grouped together in the MD-AMPDU. The instructions are also executable to cause the processor to initiate transmission of the MD-AMPDU to the first station and to the second station via an Institute of Electrical and Electronics Engineers (IEEE) 802.11 wireless network.

In another particular implementation, an access point includes means for generating a multi-destination aggregated media access control protocol data unit (MD-AMPDU). The MD-AMPDU includes a first set of one or more media access control protocol data units (MPDUs) having a first receive address associated with a first station and a second set of one or more MPDUs having a second receive address associated with a second station. The first set of one or more MPDUs is grouped together in the MD-AMPDU and the second set of one or more MPDUs is grouped together in the MD-AMPDU. The access point also includes means for transmitting the MD-AMPDU to the first station and to the second station via an Institute of Electrical and Electronics Engineers (IEEE) 802.11 wireless network.

One advantage provided by at least one of the disclosed implementations is reduced congestion within a wireless network. For example, an access point may arrange data (e.g., MPDUs) addressed to multiple stations in a single wireless transmission to circumvent the need to broadcast multiple wireless transmissions. Other implementations, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a particular implementation of a system that supports techniques to transmit a physical layer protocol data unit (PPDU) having media access control protocol data units (MPDUs) addressed to different stations;

FIG. 2 depicts flow diagrams of illustrative methods for transmitting a PPDU having MPDUs addressed to different stations;

FIG. 3 is a diagram of a particular implementation of a system that supports techniques to group data in wireless transmissions;

FIG. 4 depicts a flow diagram of an illustrative method for grouping data in wireless transmissions;

FIG. 5 illustrates a multi-band physical layer protocol data unit (PPDU) according to the present disclosure;

FIG. 6 is a flow diagram of an illustrative method for assigning stations to different frequency bands in a multi-band PPDU to reduce a transmission time of the multi-band PPDU; and

FIG. 7 is a diagram of an access point that is operable to support various embodiments of one or more methods, systems, apparatuses, and/or computer-readable media disclosed herein.

### VI. DETAILED DESCRIPTION

Particular implementations of the present disclosure are described below with reference to the drawings. In the description, common features are designated by common reference numbers throughout the drawings.

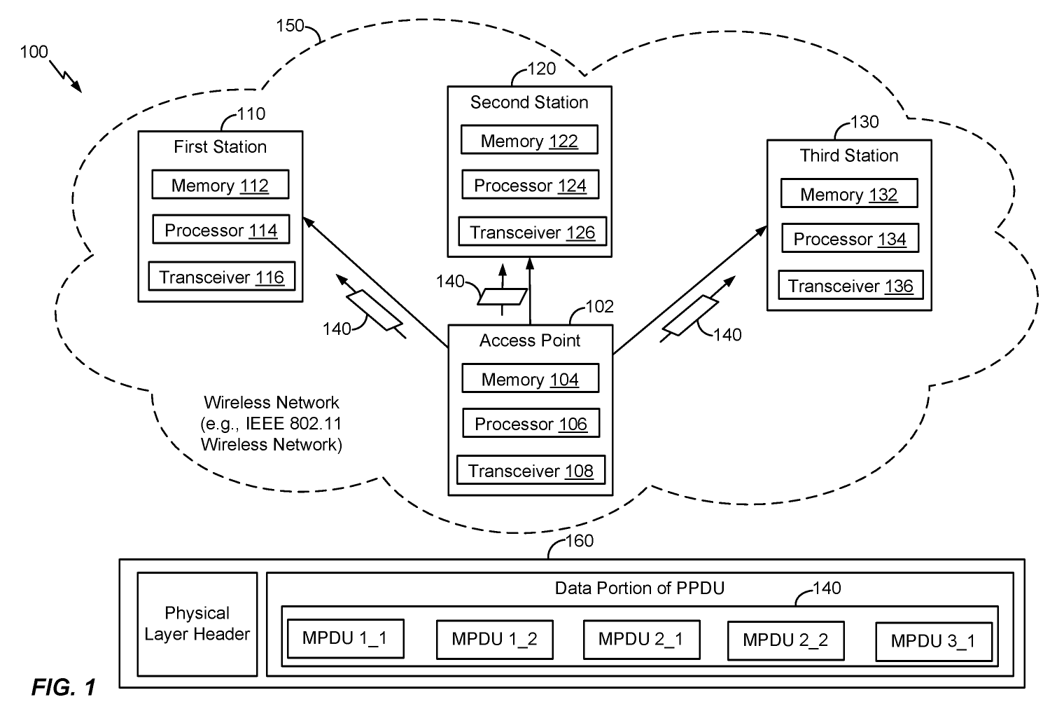

Referring to FIG. 1, a particular implementation of a system 100 that includes a wireless network that supports wireless transmissions between an access point and multiple stations is shown. The system 100 includes a wireless network 150 including an access point 102, a first station 110, a second station 120, and a third station 130. Although three stations 110, 120, 130 are illustrated in the wireless network 150, additional (or fewer) stations may be included in the wireless network 150. For example, in a particular implementation, twenty stations may be included in the wireless network 150. The wireless network 150 may operate in accordance with one or more standards, such as an Institute of Electrical and Electronics Engineers (IEEE) 802.11 standard.

The following description with respect to FIG. 1 describes techniques to transmit a physical layer protocol data unit (PPDU) having media access control protocol data units (MPDUs) addressed to different stations 110, 120, 130 to reduce congestion in the wireless network and techniques to reduce power consumption at one or more stations 110, 120, 130 receiving a wireless transmission from the access point 102. For example, the access point 102 may sequentially arrange data in the wireless transmission such that first data addressed to the first station 110 is grouped together, second data addressed to the second station 120 is grouped together, and third data addressed to the third station 130 is grouped together. Upon receiving the wireless transmission, the first station 110 may enter into a low-power mode after decoding the first data, the second station 120 may enter into a low-power mode after decoding the second data, and the third station 130 may enter into a low-power mode after decoding the third data. By grouping data addressed to a particular station together, after decoding at least a portion of data addressed to the particular station, the particular station may determine to enter into a low-power mode after detecting data addressed to another station. For example, the particular station may determine that there is no more data in the wireless transmission that is addressed to the particular station after detecting data addressed to another station.

The access point 102 includes a memory 104, a processor 106, and a transceiver 108. As described below, the access point 102 may be configured to generate a multi-destination aggregated media access control protocol data unit (MD-AMPDU) 140. For example, the memory 104 may store instructions that are executable by the processor 106 to generate the MD-AMPDU 140. Additionally, the access point 102 may transmit (e.g., broadcast) the MD-AMPDU 140 to each station 110, 120, 130 in the wireless network 150. For example, the transceiver 108 may transmit the MD-AMPDU 140 to each station 110, 120, 130 in the wireless network 150.

The first station 110 includes a memory 112, a processor 114, and a transceiver 116. As described below, the first station 110 may be configured to receive the MD-AMPDU 140 from the access point 102 and to enter into a low-power mode after decoding MPDUs within the MD-AMPDU 140 that are addressed to the first station 110. For example, the transceiver 116 may receive the MD-AMPDU 140 from the access point 102. Upon receiving the MD-AMPDU 140, the processor 114 may decode MPDUs within the MD-AMPDU 140 that are addressed to the first station 110 and may enter into the low-power mode after decoding the last MPDU that is addressed to the first station 110. The processor 114 may determine that the last MPDU addressed to the first station 110 has been decoded after detecting an MPDU addressed to another station.

The second station 120 includes a memory 122, a processor 124, and a transceiver 126. As described below, the second station 120 may be configured to receive the MD-AMPDU 140 from the access point 102 and to enter into a low-power mode after decoding MPDUs within the MD-AMPDU 140 that are addressed to the second station 120. For example, the transceiver 126 may receive the MD-AMPDU 140 from the access point 102. Upon receiving the MD-AMPDU 140, the processor 124 may decode MPDUs within the MD-AMPDU 140 that are addressed to the second station 120 and may enter into the low-power mode after decoding the last MPDU that is addressed to the second station 120.

The third station 130 includes a memory 132, a processor 134, and a transceiver 136. As described below, the third station 130 may be configured to receive the MD-AMPDU 140 from the access point 102 and to enter into a low-power mode after decoding MPDUs within the MD-AMPDU 140 that are addressed to the third station 130. For example, the transceiver 136 may receive the MD-AMPDU 140 from the access point 102. Upon receiving the MD-AMPDU 140, the processor 134 may decode MPDUs within the MD-AMPDU 140 that are addressed to the third station 130 and may enter into the low-power mode after decoding the last MPDU that is addressed to the third station 130.

The MD-AMPDU 140 generated by the access point 102 may be included in a PPDU 160. The PPDU 160 includes a physical layer header and a data portion having the MD-AMPDU 140. The MD-AMPDU 140 may include a first set of one or more MPDUs (MPDU 1_1 and MPDU 1_2) having a first receive address associated with the first station 110, a second set of one or more MPDUs (MPDU 2_1 and MPDU 2_2) having a second receive address associated with the second station 120, and a third set of one or more MPDUs (MPDU 3_1) having a third receive address associated with the third station 130. The first address indicates that the first set of one or more MPDUs (MPDU 1_1 and MPDU 1_2) is to be decoded by the first station 110, the second address indicates that the second set of one or more MPDUs (MPDU 2_1 and MPDU 2_2) is to be decoded by the second station 120, and the third address indicates that the third set of one or more MPDUs (MPDU 3_1) is to be decoded by the third station 130. Each MPDU in the MD-AMPDU 140 may have a transmit address that indicates the access point 102 as the transmitter (e.g., the broadcaster).

The access point 102 may sequentially arrange the MPDUs in the MD-AMPDU 140 by receive addresses. For example, the first set of one or more MPDUs (MPDU 1_1 and MPDU 1_2) may be grouped together (e.g., sequentially arranged) in the MD-AMPDU 140 such that MPDUs addressed to stations other than the first station 110 are not “in between” the MPDUs addressed to the first station 110. The second set of one or more MPDUs (MPDU 2_1 and MPDU 2_2) may be grouped together in the MD-AMPDU 140 such that MPDUs addressed to stations other than the second station 120 are not “in between” the MPDUs addressed to the second station 120. The third set of one or more MPDUs (MPDU 3_1) may also be grouped together.

The processor 106 within the access point 102 may determine an order to arrange each set of MPDUs in the MD-AMPDU 140. The processor 106 may determine the order based on a data size of each set of MPDUs (e.g., based on a number of frames in each set of MPDUs). For example, the processor 106 may determine a first data size of the first set of one or more MPDUs (MPDU 1_1 and MPDU 1_2), a second data size of the second set of one or more MPDUs (MPDU 2_1 and MPDU 2_2), and a third data size of the third set of one or more MPDUs (MPDU 3_1). After determining the data sizes for each set of MPDUs, the processor 106 may arrange each set of MPDUs from smallest data size to largest data size.

To illustrate, if the first data size is smaller than the second data size and the second data size is smaller than the third data size, the processor 106 may arrange the first set of one or more MPDUs (MPDU 1_1 and MPDU 1_2) ahead of the second set of one or more MPDUs (MPDU 2_1 and MPDU 2_2) and may arrange the second set of one or more MPDUs (MPDU 2_1 and MPDU 2_2) ahead of the third set of one or more MPDUs (MPDU 3_1). If the second data size is smaller than the third data size and the third data size is smaller than the first data size, the processor 106 may arrange the second set of one or more MPDUs (MPDU 2_1 and MPDU 2_2) ahead of the third set of one or more MPDUs (MPDU 3_1) and may arrange the third set of one or more MPDUs (MPDU 3_1) ahead of the first set of one or more MPDUs (MPDU 1_1 and MPDU 1_2). Similar techniques may be implemented to arrange each set of MPDUs from smallest data size to largest data size in other scenarios. Arranging the MPDUs from smallest data size to largest data size may enable stations receiving a small set of MPDUs to decode the MPDUs and enter into the low-power mode prior to detection of a large set of MPDUs. Thus, stations receiving a small set of MPDUs may remain “active” for a reduced amount of time, which may conserve power.

In another particular implementation, the processor 106 within the access point 102 may alternate (e.g., rotate) the arrangement of each set of MPDUs in response to a determination that the first data size, the second data size, and the third data size are substantially similar. For example, in a first MD-AMPDU, the processor 106 may arrange the first set of one or more MPDUs (MPDU 1_1 and MPDU 1_2) ahead of the second set of one or more MPDUs (MPDU 2_1 and MPDU 2_2) and may arrange the second set of one or more MPDUs (MPDU 2_1 and MPDU 2_2) ahead of the third set of one or more MPDUs (MPDU 3_1). In a second MD-AMPDU, the processor 106 may arrange the second set of one or more MPDUs (MPDU 2_1 and MPDU 2_2) ahead of the third set of one or more MPDUs (MPDU 3_1) and may arrange the third set of one or more MPDUs (MPDU 3_1) ahead of the first set of one or more MPDUs (MPDU 1_1 and MPDU 1_2). In a third MD-AMPDU, the processor 106 may arrange the third set of one or more MPDUs (MPDU 3_1) ahead of the first set of one or more MPDUs (MPDU 1_1 and MPDU 1_2) and may arrange the first set of one or more MPDUs (MPDU 1_1 and MPDU 1_2) ahead of the second set of one or more MPDUs (MPDU 2_1 and MPDU 2_2).

After generating the MD-AMPDU 140, the access point 102 may be configured to transmit the PPDU 160 (e.g., transmit the MD-AMPDU 140) to each station 110, 120, 130 in the wireless network 150. For example, the transceiver 108 may transmit the MD-AMPDU 140 according to an IEEE 802.11 standard.

Each station 110, 120, 130 may receive the broadcast that includes the MD-AMPDU 140 and may use power-saving techniques to enter a low-power mode after decoding MPDUs associated with the respective station. For example, the first station 110 may operate in a high-power mode and receive the MD-AMPDU 140. The first station 110 may remain in the high-power mode to decode the first set of one or more MPDUs (MPDU 1_1 and MPDU 1_2). For example, the first station 110 may remain in the high-power mode to decode each MPDU in the MD-AMPDU 140 having the first receive address (e.g., a receive address associated with the first station 110). After decoding at least one MPDU in the first set of one or more MPDUs (MPDU 1_1 and MPDU 1_2), the processor 114 within the first station 110 may cause the first station 110 to enter into the low-power mode upon detecting an MPDU addressed to another station. Because the access point 102 groups together the first set of one or more MPDUs (MPDU 1_1 and MPDU 1_2) in the MD-AMPDU 140, after decoding an MPDU addressed to the first station 110, the processor 114 may determine that there are no more MPDUs in the MD-AMPDU 140 addressed to the first station 110 after detecting an MPDU addressed to another station. Thus, the processor 114 may “power-down” the first station 110 to conserve battery power.

As another example, the second station 120 may operate in a high-power mode and receive the MD-AMPDU 140. The second station 120 may remain in the high-power mode to decode the second set of one or more MPDUs (MPDU 2_1 and MPDU 2_2). For example, the second station 120 may remain in the high-power mode to decode each MPDU in the MD-AMPDU 140 having the second receive address (e.g., a receive address associated with the second station 120). After decoding at least one MPDU in the second set of one or more MPDUs (MPDU 2_1 and MPDU 2_2), the processor 124 within the second station 120 may cause the second station 120 to enter into the low-power mode upon detecting an MPDU addressed to another station. Because the access point 102 groups together the second set of one or more MPDUs (MPDU 2_1 and MPDU 2_2) in the MD-AMPDU 140, after decoding an MPDU addressed to the second station 120, the processor 124 may determine that there are no more MPDUs in the MD-AMPDU 140 addressed to the second station 120 after detecting an MPDU addressed to another station. Thus, the processor 124 may “power-down” the second station 120 to conserve battery power after detecting an MPDU addressed to another station.

As another example, the third station 130 may operate in a high-power mode and receive the MD-AMPDU 140. The third station 130 may remain in the high-power mode to decode the third set of one or more MPDUs (MPDU 3_1). For example, the third station 130 may remain in the high-power mode to decode each MPDU in the MD-AMPDU 140 having the third receive address (e.g., a receive address associated with the third station 130). After decoding at least one MPDU in the third set of one or more MPDUs (MPDU 3_1), the processor 134 within the third station 130 may enter the third station 130 into the low-power mode upon detecting an MPDU addressed to another station. Because the access point 102 groups together the third set of one or more MPDUs (MPDU 3_1) in the MD-AMPDU 140, after decoding an MPDU addressed to the third station 130, the processor 134 may determine that there are no more MPDUs in the MD-AMPDU 140 addressed to the third station 130 after detecting an MPDU addressed to another station. Thus, the processor 134 may “power-down” the third station 130 to conserve battery power.

The MPDU arrangement techniques described with respect to the system 100 of FIG. 1 may enable efficient power management at the stations 110, 120, 130. By arranging each set of MPDUs in the MD-AMPDU 140 from smallest data size to largest data size, the system 100 enables a particular station that is set to receive a set of MPDUs with a relatively small data size to enter into a low-power mode after decoding the set of MPDUs. For example, the particular station may enter into the low-power mode relatively early after initially receiving the MD-AMPDU 140 because the MPDUs addressed to the station are arranged (e.g., positioned) at the “front” of the MD-AMPDU 140.

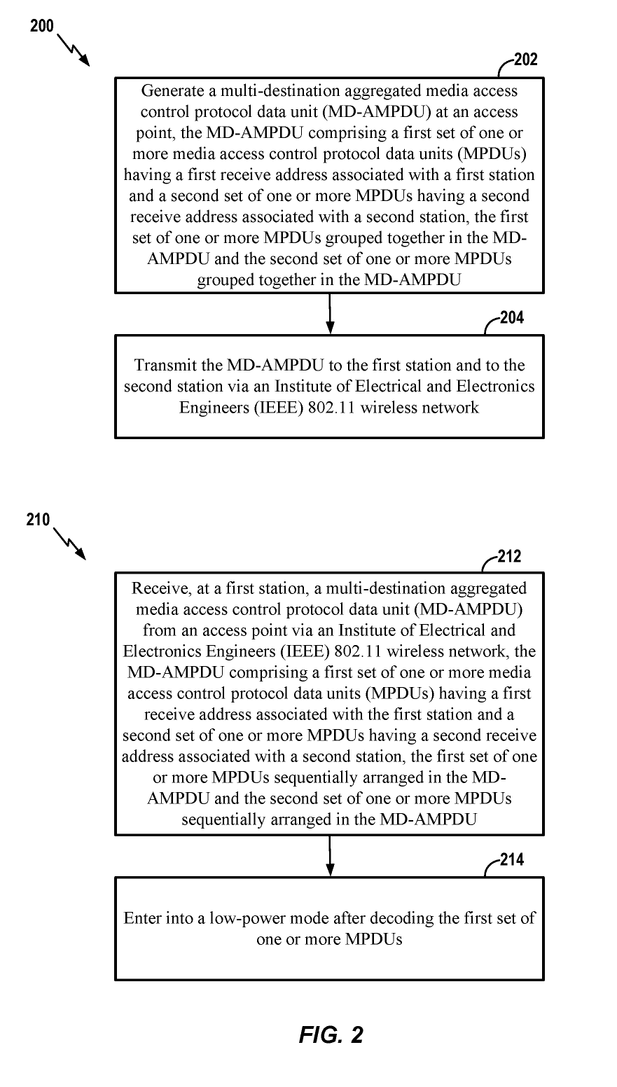

Referring to FIG. 2, particular implementations of methods 200, 210 for transmitting a PPDU having MPDUs addressed to different stations are shown. The first method 200 may be performed by the access point 102 of FIG. 1. The second method 210 may be performed by one or more of the stations 110, 120, 130 of FIG. 1.

The first method 200 includes generating a MD-AMPDU at an access point, at 202. For example, referring to FIG. 1, the access point 102 may generate the MD-AMPDU 140. The MD-AMPDU 140 may include the first set of one or more MPDUs (MPDU 1_1 and MPDU 1_2) having the first receive address associated with the first station 110 and may include the second set of one or more MPDUs (MPDU 2_1 and MPDU 2_2) having the second receive address associated with the second station 120. The first set of one or more MPDUs (MPDU 1_1 and MPDU 1_2) may be grouped together in the MD-AMPDU 140. For example, the first set of one or more MPDUs (MPDU 1_1 and MPDU 1_2) may be arranged such that MPDUs addressed to stations other than the first station 110 are not “in between” the MPDUs addressed to the first station 110. The second set of one or more MPDUs (MPDU 2_1 and MPDU 2_2) may also be grouped together in the MD-AMPDU 140. For example, the second set of one or more MPDUs (MPDU 2_1 and MPDU 2_2) may be arranged such that MPDUs addressed to stations other than the second station 120 are not “in between” the MPDUs addressed to the second station 120.

The MD-AMPDU may be transmitted to the first station and to the second station via an IEEE 802.11 wireless network, at 204. For example, referring to FIG. 1, the access point 102 may transmit the PPDU 160 (e.g., transmit the MD-AMPDU 140) to each station 110, 120, 130 in the wireless network 150. For example, the transceiver 108 may transmit the MD-AMPDU 140 according to an IEEE 802.11 standard.

The first method 200 of FIG. 2 may enable efficient power management at the stations 110, 120, 130. By arranging each set of MPDUs in the MD-AMPDU 140 from smallest data size to largest data size, the system 100 enables a particular station that is set to receive a set of MPDUs with a relatively small data size to enter into a low-power mode after decoding the set of MPDUs. For example, the particular station may enter into the low-power mode relatively early after initially receiving the MD-AMPDU 140 because the MPDUs addressed to the station are arranged (e.g., positioned) at the “front” of the MD-AMPDU 140.

The second method 210 includes receiving, at a first station, a MD-AMPDU from an access point via an IEEE 802.11 wireless network, at 212. For example, referring to FIG. 1, the first station 110 may receive the MD-AMPDU 140 from the access point 102 via the wireless network 150.

The receiving station may enter into a low-power mode after decoding the first set of one or more MPDUs (and after decoding another MPDU addressed to another station), at 214. For example, referring to FIG. 1, the first station 110 may operate in a high-power mode and receive the MD-AMPDU 140. The first station 110 may remain in the high-power mode to decode the first set of one or more MPDUs (MPDU 1_1 and MPDU 1_2). For example, the first station 110 may remain in the high-power mode to decode each MPDU in the MD-AMPDU 140 having the first receive address (e.g., a receive address associated with the first station 110). After decoding at least one MPDU in the first set of one or more MPDUs (MPDU 1_1 and MPDU 1_2), the processor 114 within the first station 110 may enter the first station 110 into the low-power mode upon detecting an MPDU addressed to another station. Because the access point 102 groups together the first set of one or more MPDUs (MPDU 1_1 and MPDU 1_2) in the MD-AMPDU 140, after decoding an MPDU addressed to the first station 110, the processor 114 may determine that there are no more MPDUs in the MD-AMPDU 140 addressed to the first station 110 after detecting an MPDU addressed to another station. Thus, the processor 114 may “power-down” the first station 110 to conserve battery power.

The second method 210 of FIG. 2 may enable efficient power management at the stations 110, 120, 130. By arranging each set of MPDUs in the MD-AMPDU 140 from smallest data size to largest data size, the system 100 enables a particular station that is set to receive a set of MPDUs with a relatively small data size to enter into a low-power mode after decoding the set of MPDUs. For example, the particular station may enter into the low-power mode relatively early after initially receiving the MD-AMPDU 140 because the MPDUs addressed to the station are arranged (e.g., positioned) at the “front” of the MD-AMPDU 140.

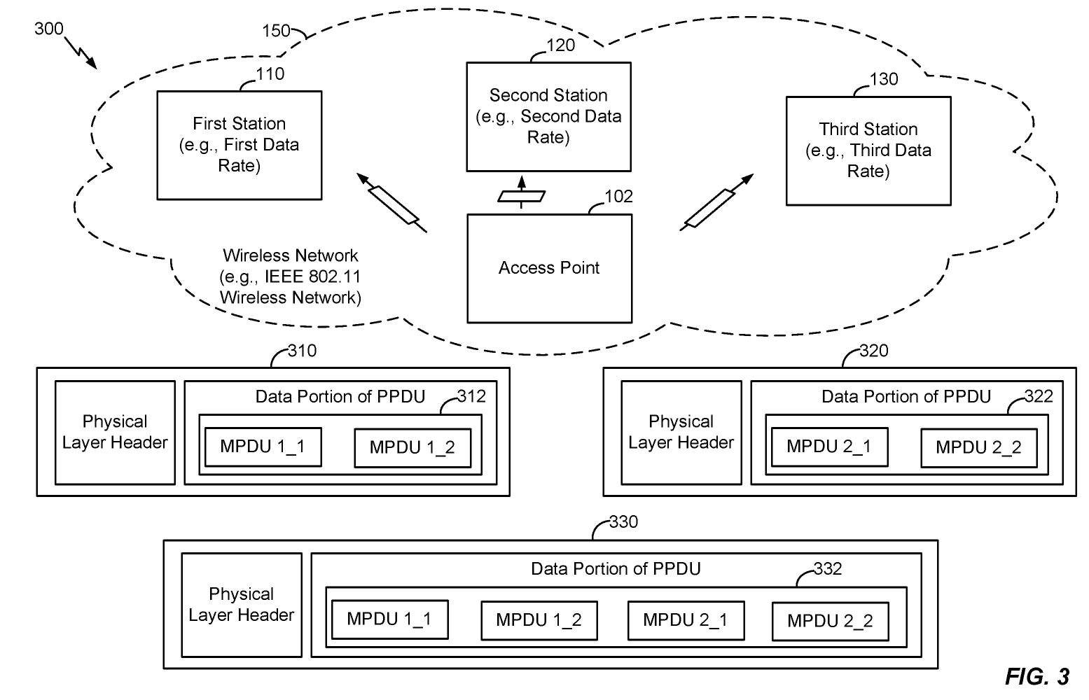

Referring to FIG. 3, another particular implementation of a system 300 that includes a wireless network that supports wireless transmissions between an access point and multiple stations is shown. The system 100 includes the wireless network 150 including the access point 102, the first station 110, the second station 120, and the third station 130.

The following description with respect to FIG. 3 describes techniques to group data in wireless transmissions provided to one or more stations 110, 120, 130. The grouping techniques may reduce transmission times and overhead in the wireless network 150. For example, each station 110, 120, 130 may have a distinct data rate (e.g., a “maximum” data rate) to receive a packet. The access point 102 may determine whether it would be more efficient (e.g., faster) to broadcast multiple wireless transmissions to the stations 110, 120,130 (where each wireless transmission includes data addressed to a particular station 110, 120, 130) or whether it would be more efficient to group data addressed to multiple stations 110, 120, 130 into a single wireless transmission and broadcast a single wireless transmission to each station 110, 120, 130.

With respect to FIG. 3, the access point 102 may broadcast PPDUs within a single band. For example, each station 110, 120, 130 may operate on a common frequency band and the access point 102 may broadcast PPDUs to each station on the common frequency band. Thus, a single PPDU (as opposed to multiple PPDUs) may be broadcast to the stations 110, 120, 130 on the common frequency band.

The first station 110 may have a first modulation and coding scheme (MCS) that enables the first station 110 to receive MPDUs at a first data rate. The second station 120 may have a second MCS that enables the second station 120 to receive MPDUs at a second data rate. Additionally, the third station 130 may have a third MCS that enables the third station 130 to receive MPDUs at a third data rate. The first data rate is greater than the second data rate, and the second data rate is greater than the third data rate.

The third station 130 may be “dominant” to first station 110 and to the second station 120. As used herein, a “dominant” station may have a lower data rate compared to another station (e.g., a “non-dominant” station). The non-dominant station may receive data at the data rate of the dominant station; however, the dominant station may not receive data at the data rate of the non-dominant station. Additionally, the second station 120 may be dominant to the first station 110.

The access point 102 may be configured to group MPDUs in wireless transmissions (e.g., PPDUs) to reduce transmission times on the common frequency band shared by the stations 110, 120, 130. To illustrate, the access point 102 may be configured to determine a first transmission time for transmitting a first PPDU 310 to the first station 110 at the first data rate. The first PPDU 310 includes a physical layer header and a data portion having an aggregated MPDU (AMPDU) 312. The AMPDU 312 includes the first set of one or more MPDUs (MPDU 1_1 and MPDU 1_2). After determining the first transmission time for transmitting the first PPDU 310 to the first station 110, the access point 102 may determine a second transmission time for transmitting a second PPDU 320 to the second station 120 at the second data rate. The second PPDU 320 includes a physical layer header and a data portion having an AMPDU 322. The AMPDU 322 includes the second set of one or more MPDUs (MPDU 2_1 and MPDU 2_2).

The access point 102 may also be configured to determine a third transmission time for transmitting a third PPDU 330 to the first station 110 and to the second station 120 at the second data rate. The third PPDU 330 would be sent at the second data rate because the second station 120 is dominant to the first station 110. The third PPDU 330 includes a physical layer header and a data portion having an MD-AMPDU 332. The MD-AMPDU 332 includes the first set of one or more MPDUs (MPDU 1_1 and MPDU 1_2) and the second set of one or more MPDUs (MPDU 2_1 and MPDU 2_2).

The access point 102 may be configured to determine whether the third transmission time is less than a sum of the first transmission time and the second transmission time. In a particular implementation, the access point 102 may factor in a short inter-frame space (SIFS) time period (e.g., approximately fifteen microseconds) between transmitting the first PPDU 310 and transmitting the second PPDU 320. For example, the access point may determine whether the third transmission time is less than the sum of the first transmission time, the second transmission time, and the SIFS.

If the third transmission time is less than the sum of the first transmission time and the second transmission time (and optionally the SIFS time period), the access point 102 may group the first set of one or more MPDUs (MPDU 1_1 and MPDU 1_2) and the second set of one or more MPDUs (MPDU 2_1 and MPDU 2_2) into the MD-AMPDU 332 and may transmit (e.g., broadcast) the MD-AMPDU 332 to the stations 110, 120 to reduce transmission time on the common frequency band. For example, the access point 102 may determine that it is more efficient (e.g., faster) to group MPDUs addressed to the first station 110 with MPDUs addressed to the second station 120 and broadcast the grouped MPDUs as an MD-AMPDU as opposed to broadcasting two AMPDUs.

The following pseudo-code may be implemented at the access point 102 to perform the grouping techniques described with respect to FIG. 3:

```
for i=1 ... N−i
  if (PPDU(G(i), MCS(i)) + SIFS + PPDU(G(i+ 1), MCS(i+ 1)) >
    PPDU(G(i) U G(i+ 1), MCS(i+ 1)))
      G(i+ 1) = G(i) U G(i+ 1)
      G(i) = Null Set
end
```

The MPDU grouping techniques described with respect to the system 300 of FIG. 3 may enable efficient use of a frequency band shared by the stations 110, 120, 130. For example, the access point 102 may use the grouping techniques to reduce the transmission times of wireless transmissions (e.g., PPDUs) on the frequency band. To illustrate, the access point 102 may determine whether it would be more efficient to group MPDUs addressed to different stations in a relatively long PPDU (and broadcast the relatively long PPDU to the stations 110, 120, 130) or whether it would be more efficient to generate relatively short PPDUs that include MPDUs addressed to single stations (and sequentially broadcast multiple relatively short PPDUs to the stations 110, 120, 130).

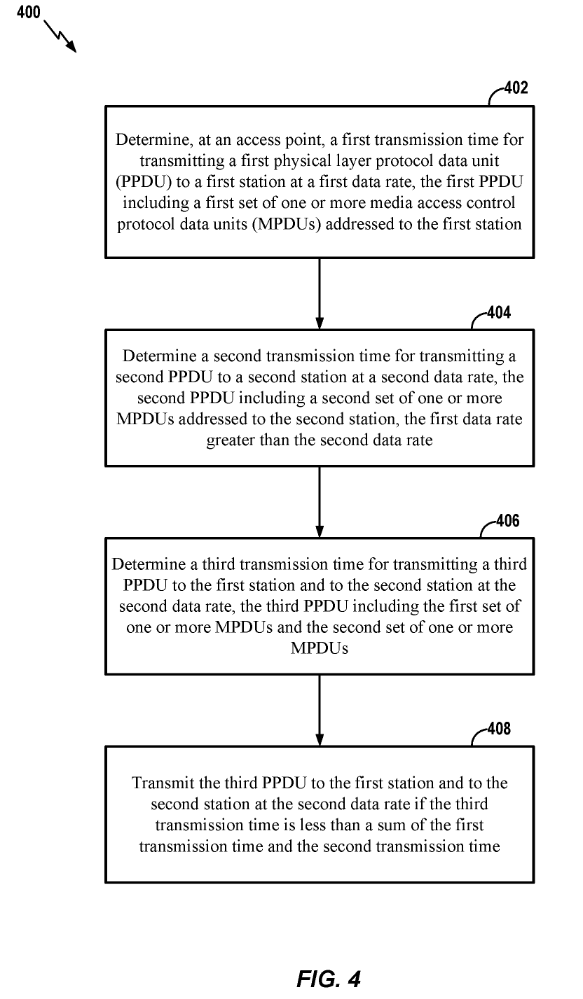

Referring to FIG. 4, a particular implementation of a method 400 for grouping MPDUs in wireless transmissions to reduce transmission times is shown. The method 400 may be performed by the access point 102 of FIG. 3.

The method 400 includes determining, at an access point, a first transmission time for transmitting a first PDDU to a first station at a first data rate, at 402. For example, referring to FIG. 3, the access point 102 may determine the first transmission time for transmitting the first PPDU 310 to the first station 110 at the first data rate. The first PPDU 310 includes the first set of one or more MPDUs (MPDU 1_1 and MPDU 1_2) (e.g., MPDUs that are addressed to the first station 110).

A second transmission time for transmitting a second PPDU to a second station at a second data rate may be determined, at 404. For example, referring to FIG. 3, after determining the first transmission time for transmitting the first PPDU 310 to the first station 110, the access point 102 may determine the second transmission time for transmitting the second PPDU 320 to the second station 120 at the second data rate. The second PPDU 320 includes the second set of one or more MPDUs (MPDU 2_1 and MPDU 2_2) (e.g., MPDUs that are addressed to the second station 120). The first data rate may be greater than the second data rate.

A third transmission time for transmitting a third PPDU to the first station and to the second station at the second data rate may be determined, at 406. For example, referring to FIG. 3, the access point 102 may determine the third transmission time for transmitting the third PPDU 330 to the first station 110 and to the second station 120 at the second data rate. The third PPDU 330 would be sent at the second data rate because the second station 120 is dominant to the first station 110. The third PPDU 330 includes the MD-AMPDU 332 including the first set of one or more MPDUs (MPDU 1_1 and MPDU 1_2) and the second set of one or more MPDUs (MPDU 2_1 and MPDU 2_2).

If the third transmission time is less than a sum of the first transmission time and the second transmission time and the SIFS time period, the third PPDU may be transmitted to the first station and to the second station at the second data rate, at 408. For example, referring to FIG. 3, if the third transmission time is less than the sum of the first transmission time and the second transmission time, the access point 102 may group the first set of one or more MPDUs (MPDU 1_1 and MPDU 1_2) and the second set of one or more MPDUs (MPDU 2_1 and MPDU 2_2) into the MD-AMPDU 332 and may transmit (e.g., broadcast) the MD-AMPDU 332 to the stations 110, 120 to reduce transmission time on the common frequency band. For example, the access point 102 may determine that it is more efficient (e.g., faster) to group MPDUs addressed to the first station 110 with MPDUs addressed to the second station 120 and broadcast the grouped MPDUs as an MD-AMPDU as opposed to broadcasting two separate AMPDUs.

In a particular implementation, the method 400 may include determining a fourth transmission time for transmitting a fourth PPDU to a third station at a third data rate. For example, referring to FIG. 3, the access point 102 may determine a fourth transmission time for transmitting a fourth PPDU (not shown) to the third station 130 at the third data rate. The fourth PPDU may include a third set of one or more MPDUs (not shown) addressed to the third station 130. The method 400 may also include determining a fifth transmission time for transmitting a fifth PPDU to the first station, to the second station, and to the third station at the third data rate. For example, referring to FIG. 3, the access point 102 may determine a fifth transmission time for transmitting a fifth PPDU (not shown) to the first station 110, to the second station 120, and to the third station 130 at the third data rate. The fifth PPDU may include the first set of one or more MPDUs (MPDU 1_1 and MPDU 1_2), the second set of one or more MPDUs (MPDU 2_1 and MPDU 2_2), and the third set of one or more MPDUs. The access point 102 may transmit the fifth PPDU to the each station 110-130 if the fifth transmission time is less than a sum of the first transmission time, the second transmission time, and the fourth transmission time as well as less than a sum of the third transmission time and the fourth transmission time.

The method 400 of FIG. 4 may enable efficient use of a frequency band shared by the stations 110, 120, 130. For example, the access point 102 may use the grouping techniques to reduce the transmission times of wireless transmissions (e.g., PPDUs) on the frequency band. To illustrate, the access point 102 may determine whether it would be more efficient to group MPDUs addressed to different stations in a relatively long PPDU (and broadcast the relatively long PPDU to the stations 110, 120, 130) or whether it would be more efficient to generate relatively short PPDUs that include MPDUs addressed to single stations (and sequentially broadcast multiple relatively short PPDUs to the stations 110, 120, 130).

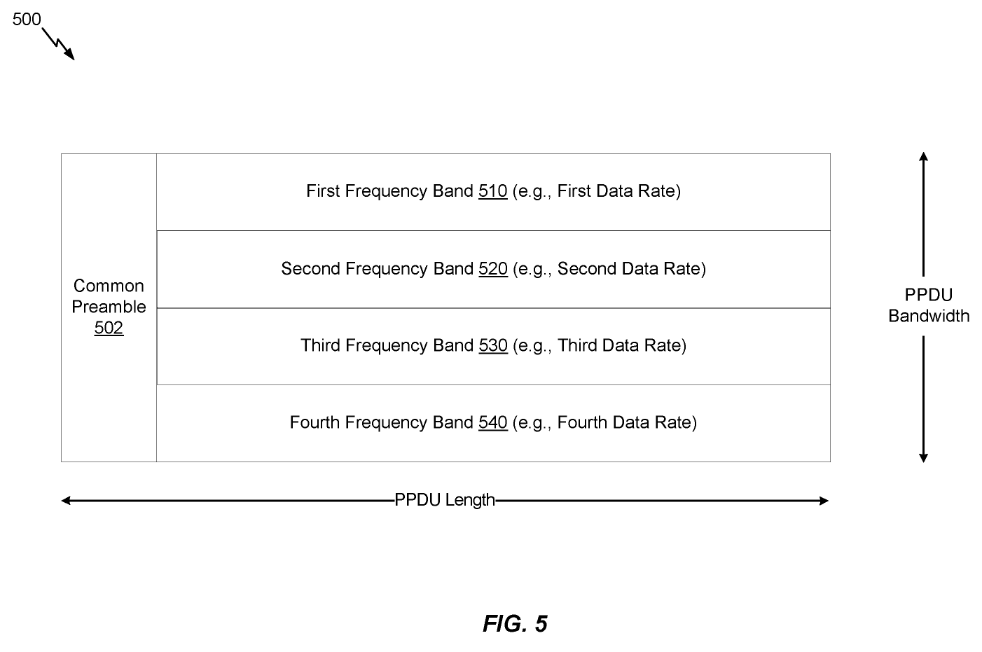

Referring to FIG. 5, a particular implementation of a multi-band PPDU 500 is shown. The multi-band PPDU 500 may be generated by the access point 102 of FIG. 1 and may be broadcasted to the stations 110, 120, 130 of FIG. 1. The following description with respect to FIG. 5 describes techniques to assign stations to different frequency bands of the multi-band PPDU 500. Assigning stations to different frequency bands may reduce the size (e.g., a PPDU length) of the multi-band PPDU 500 and may increase (e.g., “maximize”) utilization of the frequency bands of the multi-band PPDU 500.

The multi-band PPDU 500 may include multiple frequency bands 510-540 and a common preamble 502 that is distributed across the frequency bands 510-540. In the illustrative implementation of FIG. 5, the multi-band PPDU 500 may include a first frequency band 510, a second frequency band 520, a third frequency band 530, and a fourth frequency band 540. Each frequency band 510-540 may include an MD-AMPDU to carry data (e.g., MPDUs) for multiple stations 110-130. In a particular implementation, each frequency band 510-540 may have a different data rate. For example, the first frequency band 510 may have a first data rate, the second frequency band 520 may have a second data rate, the third frequency band 530 may have a third data rate, and the fourth frequency band 540 may have a fourth data rate.

Although four frequency bands 510-540 are illustrated in the multi-band PPDU 500, in other implementations, the multi-band PPDU 500 may include additional (or fewer) frequency bands. Although each frequency band 510-540 is illustrated to have a different data rate, in other implementations, two or more frequency bands 510-540 in the multi-band PPDU may have similar data rates.

The bandwidth of the frequency bands 510-540 may define the PPDU bandwidth of the multi-band PPDU 500. As a non-limiting illustrative example, each frequency band 510-540 may have a bandwidth of 20 megahertz (MHz) and the PPDU bandwidth may be 80 MHz. In other implementations, one frequency band may have a different bandwidth than the other frequency bands. As a non-limiting example, a multi-band PPDU according to the present disclosure may include three frequency bands. The first frequency band may have a bandwidth of 40 MHz and each of the other two frequency bands may have a bandwidth of 20 MHz.

To reduce the PPDU length of the multi-band PPDU 500 and to increase utilization of the frequency bands 510-540, the access point 102 of FIG. 1 may use an algorithm to assign (and reassign) stations 110-130 to different frequency bands 510-540. During each iteration of the algorithm, the access point 102 may determine whether the PPDU length of the multi-band PPDU 500 has decreased (compared to a previous iteration) and whether at least one station 110-130 is assigned to each frequency band 510-540. If the PPDU length of the multi-band PPDU 500 has not decreased and at least one station 110-130 is assigned to each frequency band 510-540 after an iteration, then the access point 102 may configure the multi-band PPDU 500 according to the station assignments in the iteration. Otherwise, another iteration may be performed to further reduce the PPDU length of the multi-band PPDU 500.

According to the algorithm, a particular station may be assigned to no more than one frequency band. For example, if the first station 110 is assigned to the first frequency band 510, MPDUs addressed to the first station 110 may not be transmitted on the other frequency bands 520-540. The following pseudo-code may be implemented at the access point 102 of FIG. 1 to perform the assignment techniques described with respect to FIG. 5:

```
//Nband: Maximum number of bands that can be carried in the multi-band
PPDU
//MinBW: Minimum Bandwidth that can be allocated to each band
//Nband*MinBW = Total Available Bandwidth
//MCS(i): Data rate for different MCS
//G(i): Group of MPDUs comprising MPDUs from one or more
destinations
//B(i): Bandwidth allocated for MCS(i) that can be sent at MCS(i)
//NG: Number of Used Bands
//NumFreeBands: Number of Free Bands
//PPDU_Length (S, MCS, BW): Length of multi-band PPDU with set of
MPDUs in S
//IterationCount: Iteration Counter
//MaxIterations: Maximum Number of Iterations in the Algorithm
//MaxLength: Maximum of PPDU_Length across all i
NumFreeBands = Nband − NG;
Iteration Count = 0;
while (IterationCount < MaxIterations)
  while (NumFreeBands > 0)
    B(i_max) = B(i_max) + 1;
    NumFreebands = NumFreebands − 1;
  End
  For all i such that G(i) is non-empty
    For j such that G(j) is non-empty and i ≠ j
      and MCS(i) < MCS(j)
    if PPDU_Length (G(i) U G(j), MCS(i), B(i)) < MaxLength
      G(i) = G(i) U G(j);
      G(j) = Null_Set;
      NumFreeBands = NumFreeBands + B(j);
      B(j) = 0;
    End
    End
  End
End
```

Based on the pseudo-code, the access point 102 may determine whether at least one station is assigned to each frequency band 510-540 in the multi-band PPDU 500. If at least one station is assigned to each frequency band 510-540, the access point 102 may determine whether to rearrange the station assignments to reduce the PPDU length. As a non-limiting example, the access point 102 may determine that the first station 110 is assigned to the first frequency band 510 (e.g., the first set of one or more MPDUs (MPDU 1_1 and MPDU 1_2) is assigned to be transmitted to the first station 110 via the first frequency band 510), the second station 120 is assigned to the second frequency band 520 (e.g., the second set of one or more MPDUs (MPDU 2_1 and MPDU 2_2) is assigned to be transmitted to the second station 120 via the second frequency band 520), the third station 130 is assigned to the third frequency band 530 (e.g., the third set of one or more MPDUs (MPDU 3_1) is assigned to be transmitted to the third station 130 via the third frequency band 540), and a fourth station (not shown in FIG. 1) is assigned to the fourth frequency band 540.

The access point 102 may identify a “principal” frequency band. The principal frequency band may correspond to the frequency band having the longest length (e.g., the longest transmission time). For example, the length of the principal frequency band may correspond to a number of symbols that are transmitted in the principal frequency band. The more symbols that are transmitted in the principal frequency band, the longer the length of the principal frequency band. The length of the principal frequency band may define the PPDU length. The length of a particular frequency band may be based on the data rate of the particular frequency band and a data size of the MPDUs to be transmitted via the particular frequency band. As an illustrative non-limiting example, the access point 102 may identify the third frequency band 530 as the principal frequency band and the other frequency bands as “non-principal” frequency bands.

The access point 102 may group the first set of one or more MPDUs (MPDU 1_1 and MPDU 1_2) in the first frequency band 510 (e.g., a non-principal frequency band) and the second set of one or more MPDUs (MPDU 2_1 and MPDU 2_2) in the second frequency band 520 (e.g., a non-principal frequency band) into the first frequency band 510. For example, the access point 102 may move the second set of one or more MPDUs (MPDU 2_1 and MPDU 2_2) into the first frequency band 510. After grouping the first and second sets of MPDUs into the first frequency band 510, the access point 102 may determine whether a length of the first frequency band 510 is longer than a length of the third frequency band 530. If the length of the first frequency band 510 is longer than the length of the third frequency band 530, the access point 102 may assign the first station 110 to the first frequency band 510 and may assign the second station 120 to the second frequency band 520. Otherwise, the access point 102 may assign the first and second stations 110, 120 to the first frequency band 510 to “empty” the second frequency band 520. If a frequency band is empty (e.g., if a station is not assigned to a frequency band), the access point may assign a station in the principal frequency band to the empty frequency band to reduce the PPDU length.

In a particular implementation, MPDUs addressed to a single station may be spread across multiple frequency bands to reduce the PPDU length. As a non-limiting example, suppose ten MPDUs addressed to the first station 110 are assigned to the first frequency band 510, two MPDUs addressed to the second station 120 are assigned to the second frequency band 520, six MPDUs addressed to the third station 130 are assigned to the third frequency band 530, and six MPDUs addressed to the fourth station are assigned to the fourth frequency band 540. If each frequency band 510-540 has a common bandwidth (e.g., 20 MHz) and a common data rate, the access point 102 may assign (e.g., move) four of the MPDUs addressed to the first station 110 from the first frequency band 510 to the second frequency band 520. By assigning four of the MPDUs addressed to the first station 110 to the second frequency band 520, each frequency band 510-540 will be assigned six MPDUs, which may reduce the PPDU length (e.g., the PPDU length will be based on each frequency band carrying six MPDUs as opposed to based on a single frequency band having an extended length to support carrying ten MPDUs).

The techniques described with respect to FIG. 5 may enable the access point 102 to reduce transmission time by reducing the PPDU length of the multi-band PPDU 500. For example, the access point 102 may assign different stations to different frequency bands 510-540 to increase (e.g., “maximize”) utilization of each frequency band 510-540. Utilizing each frequency band 510-540 may substantially prevent any particular frequency band from being “over-utilized” such that length of the particular frequency band (e.g., the transmission time of the particular frequency band) is grossly disproportional to the length of the other frequency bands, causing the length of the multi-band PPDU 500 to be unnecessarily large.

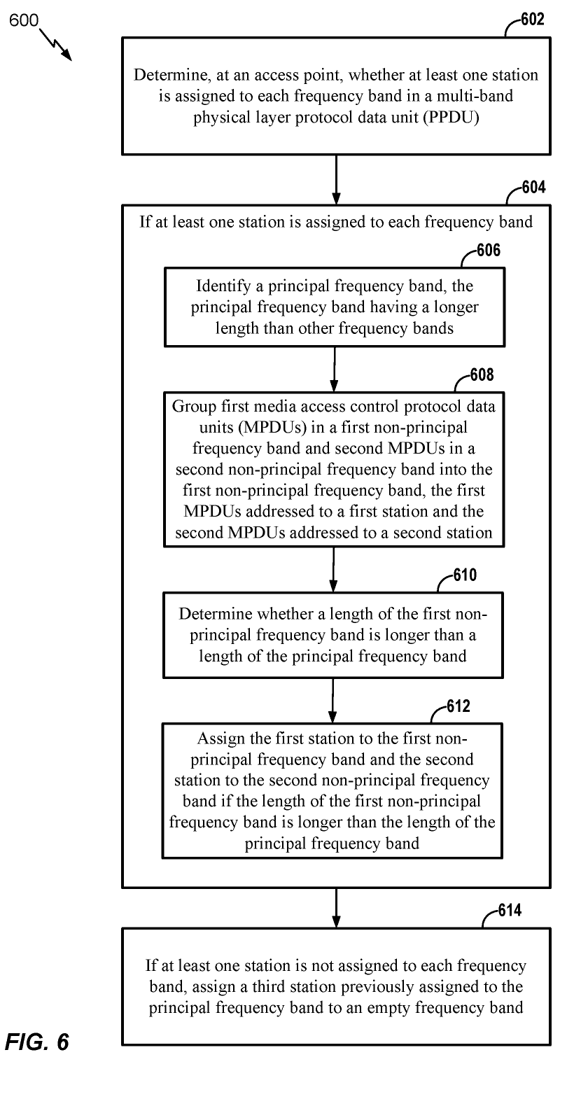

Referring to FIG. 6, a particular implementation of a method 600 for assigning stations to different frequency bands in a multi-band PPDU to reduce a length of the multi-band PPDU is shown. The method 600 may be performed by the access point 102 of FIG. 1.

The method 600 includes determining, at an access point, whether at least one station is assigned to each frequency band in a multi-band PPDU, at 602. For example, referring to FIGS. 1 and 5, the access point 102 may determine whether at least one station 110-130 is assigned to each frequency band 510-540 in the multi-band PPDU 500. If at least one station is assigned to each frequency band, at 604, the access point may identify a principal frequency band, at 606. For example, referring to FIGS. 1 and 5, the access point 102 may identify the third frequency band 530 as the principal frequency band and the other frequency bands as “non-principal” frequency bands.

First MPDUs in a first non-principal frequency band and second MPDUs in a second non-principal frequency band may be grouped into the first non-principal frequency band, at 608. For example, referring to FIGS. 1 and 5, the access point 102 may group the first set of one or more MPDUs (MPDU 1_1 and MPDU 1_2) in the first frequency band 510 (e.g., a non-principal frequency band) and the second set of one or more MPDUs (MPDU 2_1 and MPDU 2_2) in the second frequency band 520 (e.g., a non-principal frequency band) into the first frequency band 510. For example, the access point 102 may move the second set of one or more MPDUs (MPDU 2_1 and MPDU 2_2) into the first frequency band 510.

A determination of whether a length (e.g., a transmission time) of the first non-principal frequency band (after grouping) is longer than a length (e.g., a transmission time) of the principal frequency band may be made, at 610. For example, referring to FIGS. 1 and 5, after grouping the first and second sets of MPDUs into the first frequency band 510, the access point 102 may determine whether a length of the first frequency band 510 is longer than a length of the third frequency band 530.

If the length of the first non-principal frequency band is longer than the length of the principal frequency band, the first station may be assigned to the first non-principal frequency band and the second station may be assigned to the second non-principal frequency band, at 612. For example, referring to FIGS. 1 and 5, if the length of the first frequency band 510 is longer than the length of the third frequency band 530, the access point 102 may assign the first station 110 to the first frequency band 510 and may assign the second station 120 to the second frequency band 520.

If at least one station is not assigned to each frequency band, at 602, a third station previously assigned to the principal frequency band may be assigned to an empty frequency band, at 614. For example, referring to FIGS. 1 and 5, if a frequency band is empty (e.g., if a station is not assigned to a frequency band), the access point 102 may assign a station in the principal frequency band to the empty frequency band to reduce the PPDU length.

The method 600 of FIG. 6 may enable the access point 102 to reduce transmission time by reducing the PPDU length of the multi-band PPDU 500. For example, the access point 102 may assign different stations to different frequency bands 510-540 to increase (e.g., “maximize”) utilization of each frequency band 510-540. Utilizing each frequency band 510-540 may substantially prevent any particular frequency band from being “over-utilized” such that length of the particular frequency band (e.g., the transmission time of the particular frequency band) is grossly disproportional to the length of the other frequency bands, causing the length of the multi-band PPDU 500 to be unnecessarily large.

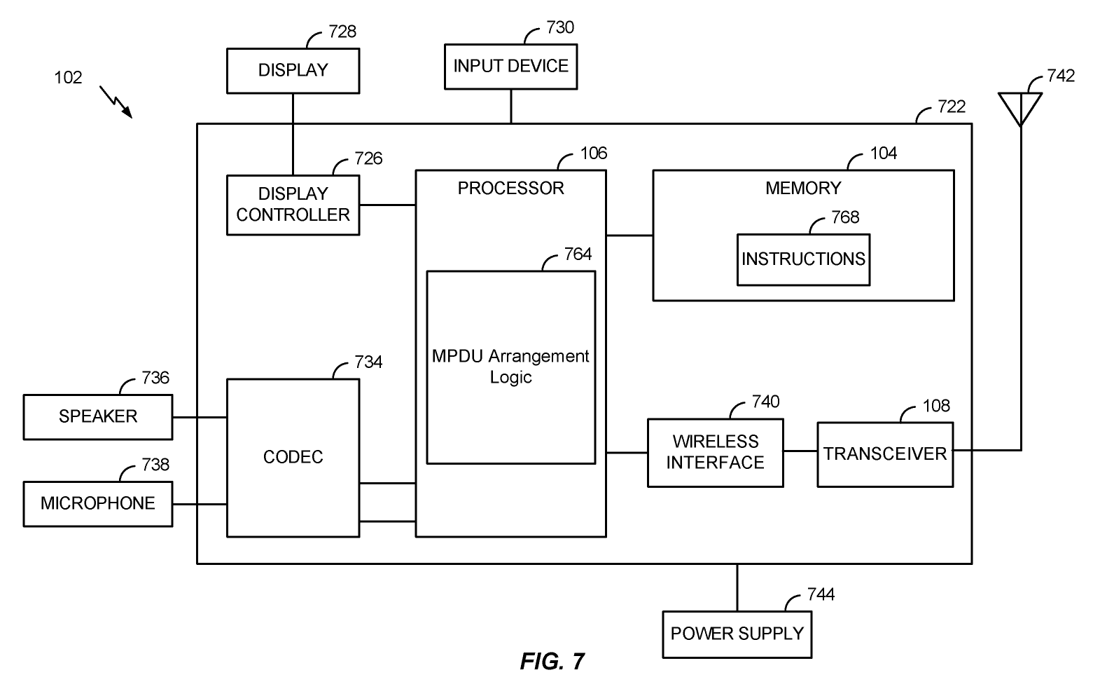

Referring to FIG. 7, a particular illustrative embodiment of the access point 102 is shown. The access point 102 includes the processor 106, such as a digital signal processor, coupled to the memory 104.

The processor 106 may be configured to execute software (e.g., a program of one or more instructions 768) stored in the memory 104. Additionally or alternatively, the processor 106 may be configured to implement one or more instructions stored in a memory of a wireless interface 740 (e.g., an IEEE 802.11 interface). For example, the wireless interface 740 may be configured to operate in accordance with an IEEE 802.11 standard. In a particular embodiment, the processor 710 may be configured to operate in accordance with the first method 200 of FIG. 2, the method 400 of FIG. 4, or the method 600 of FIG. 6. For example, the processor 106 may include MPDU arrangement logic 764 to execute the first method 200 of FIG. 2, the method 400 of FIG. 4, or the method 600 of FIG. 6.

The wireless interface 740 may be coupled to the processor 106 and to an antenna 742. For example, the wireless interface 740 may be coupled to the antenna 742 via the transceiver 108, such that wireless data received via the antenna 742 and may be provided to the processor 106.

A coder/decoder (CODEC) 734 can also be coupled to the processor 106. A speaker 736 and a microphone 738 can be coupled to the CODEC 734. A display controller 726 can be coupled to the processor 106 and to a display device 728. In a particular embodiment, the processor 106, the display controller 726, the memory 732, the CODEC 734, and the wireless interface 740 are included in a system-in-package or system-on-chip device 722. In a particular embodiment, an input device 730 and a power supply 744 are coupled to the system-on-chip device 722. Moreover, in a particular embodiment, as illustrated in FIG. 7, the display device 728, the input device 730, the speaker 736, the microphone 738, the antenna 742, and the power supply 744 are external to the system-on-chip device 722. However, each of the display device 728, the input device 730, the speaker 736, the microphone 738, the antenna 742, and the power supply 744 can be coupled to one or more components of the system-on-chip device 722, such as one or more interfaces or controllers.

In conjunction with the described implementations, a first apparatus includes means for generating MD-AMPDU. The MD-AMPDU may include a first set of one or more MPDUs having a first receive address associated with a first station and a second set of one or more MPDUs having a second receive address associated with a second station. The first set of one or more MPDUs may be grouped together in the MD-AMPDU and the second set of one or more MPDUs may be grouped together in the MD-AMPDU. For example, the means for generating the MD-AMPDU may include the processor 106 of FIGS. 1 and 7, the memory 104 of FIGS. 1 and 7, the instructions 768 of FIG. 7, the MPDU arrangement logic 764 of FIG. 7, one or more other devices, circuits, or modules, or any combination thereof.

The first apparatus may also include means for transmitting the MD-AMPDU to the first station and to the second station via an IEEE 802.11 wireless network. For example, the means for transmitting the MD-AMPDU may include the transceiver 108 of FIGS. 1 and 7, the antenna 742 of FIG. 7, one or more other devices, circuits, or modules, or any combination thereof.

In conjunction with the described implementations, a second apparatus may include means for receiving a MD-AMPDU from an access point via an IEEE 802.11 wireless network. The MD-AMPDU may include a first set of one or more MPDUs having a first receive address associated with the first station and a second set of one or more MPDUs having a second receive address associated with a second station. The first set of one or more MPDUs may be grouped together in the MD-AMPDU and the second set of one or more MPDUs may be grouped together in the MD-AMPDU. For example, the means for receiving the MD-AMPDU may include the transceiver 116 of FIG. 1, one or more other devices, circuits, or modules, or any combination thereof.

The second apparatus may also include means for entering into a low-power mode after decoding the first set of one or more MPDUs. For example, the means for entering the low-power mode may include the processor 114 of FIG. 1, the memory 112 of FIG. 1, one or more other devices, circuits, or modules, or any combination thereof.

In conjunction with the described implementations, a third apparatus may include means for determining a first transmission time for transmitting a first PPDU to a first station at a first data rate, determining a second transmission time for transmitting a second PPDU to a second station at a second data rate, and determining a third transmission time for transmitting a third PPDU to the first station and to the second station at the second data rate. The first PPDU may include a first set of one or more MPDUs addressed to the first station, the second PPDU may include a second set of one or more MPDUs addressed to the second station, and the first data rate may be greater than the second data rate. The third PPDU may include the first set of one or more MPDUs and the second set of one or more MPDUs. For example, the means for determining may include the processor 106 of FIGS. 1 and 7, the memory 104 of FIGS. 1 and 7, the instructions 768 of FIG. 7, the MPDU arrangement logic 764 of FIG. 7, one or more other devices, circuits, or modules, or any combination thereof.

The third apparatus may also include means for transmitting the third PPDU to the first station and to the second station at the second data rate if the third transmission time is less than a sum of the first transmission time and the second transmission time. For example, the means for transmitting the third PPDU may include the transceiver 108 of FIGS. 1 and 7, the antenna 742 of FIG. 7, one or more other devices, circuits, or modules, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for arranging media access control protocol data units (MPDUs) in a wireless transmission, the method comprising:
generating a multi-destination aggregated media access control protocol data unit (MD-AMPDU) at an access point, the MD-AMPDU comprising a first set of one or more MPDUs having a first receive address associated with a first station and a second set of one or more MPDUs having a second receive address associated with a second station, the first set of one or more MPDUs grouped together in the MD-AMPDU and the second set of one or more MPDUs grouped together in the MD-AMPDU; and
transmitting the MD-AMPDU from the access point to the first station and to the second station via an Institute of Electrical and Electronics Engineers (IEEE) 802.11 wireless network.

2. The method of claim 1, wherein the MD-AMPDU is transmitted according to an IEEE 802.11 standard.

3. The method of claim 1, further comprising:
determining, at the access point, a first data size of the first set of one or more MPDUs; and
determining, at the access point, a second data size of the second set of one or more MPDUs.

4. The method of claim 3, further comprising arranging, at the access point, the first set of one or more MPDUs in the MD-AMPDU ahead of the second set of one or more MPDUs in response to a determination that the first data size is smaller than the second data size.

5. The method of claim 4, wherein the first station decodes the first set of one or more MPDUs and enters into a low-power mode in response to detecting an MPDU of the second set of one or more MPDUs.

6. The method of claim 3, further comprising arranging, at the access point, the second set of one or more MPDUs in the MD-AMPDU ahead of the first set of one or more MPDUs in response to a determination that the second data size is smaller than the first data size.

7. The method of claim 6, wherein the second station decodes the second set of one or more MPDUs and enters into a low-power mode in response to detecting an MPDU of the first set of one or more MPDUs.

8. The method of claim 3, further comprising transmitting the MD-AMPDU from the access point to a third station via the IEEE 802.11 wireless network, wherein the MD-AMPDU further comprises a third set of one or more MPDUs having a third receive address associated with the third station.

9. The method of claim 8, further comprising determining, at the access point, a third data size of the third set of one or more MPDUs.

10. The method of claim 9, in response to a determination that the first size is approximately equal to the second size and the second size is approximately equal to the third size, further comprising:
arranging, at the access point, the first set of one or more MPDUs in the MD-AMPDU ahead of the second set of one or more MPDUs; and
arranging, at the access point, the second set of one or more MPDUs ahead of the third set of one or more MPDUs.

11. The method of claim 8, further comprising rotating an order that each set of one or more MPDUs is arranged in a subsequent MD-AMPDU transmitted via the IEEE 802.11 wireless network, wherein the order is rotated if a size of MPDUs having the first receive address in the subsequent MD-AMPDU is approximately equal to a size of MPDUs having the second receive address in the subsequent MD-AMPDU and if the size of MPDUs having the second receive address is approximately equal to a size of MPDUs having the third receive address in the subsequent MD-AMPDU.

12. An access point for arranging media access control protocol data units (MPDUs) in a wireless transmission, the apparatus comprising:
a processor; and
a memory storing instructions executable by the processor to perform operations comprising:
generating a multi-destination aggregated media access control protocol data unit (MD-AMPDU), the MD-AMPDU comprising a first set of one or more MPDUs having a first receive address associated with a first station and a second set of one or more MPDUs having a second receive address associated with a second station, the first set of one or more MPDUs grouped together in the MD-AMPDU and the second set of one or more MPDUs grouped together in the MD-AMPDU; and
initiating transmission of the MD-AMPDU to the first station and to the second station via an Institute of Electrical and Electronics Engineers (IEEE) 802.11 wireless network.

13. The access point of claim 12, wherein the MD-AMPDU is transmitted according to an IEEE 802.11 standard.

14. The access point of claim 12, wherein the operations further comprise:
determining a first data size of the first set of one or more MPDUs; and
determining a second data size of the second set of one or more MPDUs.

15. The access point of claim 14, wherein the operations further comprise arranging the first set of one or more MPDUs in the MD-AMPDU ahead of the second set of one or more MPDUs in response to a determination that the first data size is smaller than the second data size.

16. The access point of claim 15, wherein the first station decodes the first set of one or more MPDUs and enters into a low-power mode in response to detecting an MPDU of the second set of one or more MPDUs.

17. The access point of claim 14, wherein the operations further comprise arranging the second set of one or more MPDUs in the MD-AMPDU ahead of the first set of one or more MPDUs in response to a determination that the second data size is smaller than the first data size.

18. The access point of claim 17, wherein the second station decodes the second set of one or more MPDUs and enters into a low-power mode in response to detecting an MPDU of the first set of one or more MPDUs.

19. The access point of claim 14, wherein the MD-AMPDU is transmitted to a third station via the IEEE 802.11 wireless network, and wherein the MD-AMPDU further comprises a third set of one or more MPDUs having a third receive address associated with the third station.

20. The access point of claim 19, wherein the operations further comprise determining a third data size of the third set of one or more MPDUs.

21. The access point of claim 20, in response to a determination that the first size is approximately equal to the second size and the second size is approximately equal to the third size, the operations further comprise:
arranging the first set of one or more MPDUs in the MD-AMPDU ahead of the second set of one or more MPDUs; and
arranging the second set of one or more MPDUs ahead of the third set of one or more MPDUs.

22. The access point of claim 19, wherein the operations further comprise rotating an order that each set of one or more MPDUs is arranged in a subsequent MD-AMPDU transmitted via the IEEE 802.11 wireless network, wherein the order is rotated if a size of MPDUs having the first receive address in the subsequent MD-AMPDU is approximately equal to a size of MPDUs having the second receive address in the subsequent MD-AMPDU and if the size of MPDUs having the second receive address is approximately equal to a size of MPDUs having the third receive address in the subsequent MD-AMPDU.

23. A non-transitory computer-readable medium comprising instructions for arranging media access control protocol data units (MPDUs), the instructions, when executed by a processor within an access point, cause the processor to:
generate a multi-destination aggregated media access control protocol data unit (MD-AMPDU), the MD-AMPDU comprising a first set of one or more MPDUs having a first receive address associated with a first station and a second set of one or more MPDUs having a second receive address associated with a second station, the first set of one or more MPDUs grouped together in the MD-AMPDU and the second set of one or more MPDUs grouped together in the MD-AMPDU; and
initiate transmission of the MD-AMPDU from the access point to the first station and to the second station via an Institute of Electrical and Electronics Engineers (IEEE) 802.11 wireless network.

24. The non-transitory computer-readable medium of claim 23, wherein the MD-AMPDU is transmitted according to an IEEE 802.11 standard.

25. The non-transitory computer-readable medium of claim 23, wherein the instructions are further executable to cause the processor to:
determine, at the access point, a first data size of the first set of one or more MPDUs; and
determine, at the access point, a second data size of the second set of one or more MPDUs.

26. The non-transitory computer-readable medium of claim 25, wherein the instructions are further executable to cause the processor to arrange the first set of one or more MPDUs in the MD-AMPDU ahead of the second set of one or more MPDUs in response to a determination that the first data size is smaller than the second data size.

27. The non-transitory computer-readable medium of claim 4, wherein the first station decodes the first set of one or more MPDUs and enters into a low-power mode in response to detecting an MPDU of the second set of one or more MPDUs.

28. An access point for arranging media access control protocol data units (MPDUs) in a wireless transmission, the access point comprising:
means for generating a multi-destination aggregated media access control protocol data unit (MD-AMPDU), the MD-AMPDU comprising a first set of one or more MPDUs having a first receive address associated with a first station and a second set of one or more MPDUs having a second receive address associated with a second station, the first set of one or more MPDUs grouped together in the MD-AMPDU and the second set of one or more MPDUs grouped together in the MD-AMPDU; and
means for transmitting the MD-AMPDU to the first station and to the second station via an Institute of Electrical and Electronics Engineers (IEEE) 802.11 wireless network.

29. The access point of claim 28, wherein the MD-AMPDU is transmitted according to an IEEE 802.11 standard.

30. A method for decoding media access control protocol data units (MPDUs) in a wireless transmission to reduce power consumption, the method comprising:
receiving, at a first station, a multi-destination aggregated media access control protocol data unit (MD-AMPDU) from an access point via an Institute of Electrical and Electronics Engineers (IEEE) 802.11 wireless network, the MD-AMPDU comprising a first set of one or more MPDUs having a first receive address associated with the first station and a second set of one or more MPDUs having a second receive address associated with a second station, the first set of one or more MPDUs grouped together in the MD-AMPDU and the second set of one or more MPDUs grouped together in the MD-AMPDU; and
entering the first station into a low-power mode after decoding the first set of one or more MPDUs.

31. The method of claim 30, wherein the MD-AMPDU is transmitted according to an IEEE 802.11 standard.

32. The method of claim 30, further comprising:
decoding the first set of one or more MPDUs at the first station; and
detecting, at the first station, an MPDU of the second set of one or more MPDUs after decoding the first set of one or more MPDUs, wherein the first station enters the low-power mode in response to detecting the MPDU of the second set of one or more MPDUs.

33. A first station for decoding media access control protocol data units (MPDUs), the first station comprising:
a processor; and
a memory storing instructions executable by the processor to perform operations comprising:
receiving a multi-destination aggregated media access control protocol data unit (MD-AMPDU) from an access point via an Institute of Electrical and Electronics Engineers (IEEE) 802.11 wireless network, the MD-AMPDU comprising a first set of one or more MPDUs having a first receive address associated with the first station and a second set of one or more MPDUs having a second receive address associated with a second station, the first set of one or more MPDUs grouped together in the MD-AMPDU and the second set of one or more MPDUs grouped together in the MD-AMPDU; and
entering the first station into a low-power mode after decoding the first set of one or more MPDUs.

34. The first station of claim 33, wherein the MD-AMPDU is transmitted according to an IEEE 802.11 standard.

35. The first station of claim 33, wherein the operations further comprise:
decoding the first set of one or more MPDUs at the first station; and
detecting, at the first station, an MPDU of the second set of one or more MPDUs after decoding the first set of one or more MPDUs, wherein the first station enters the low-power mode in response to detecting the MPDU of the second set of one or more MPDUs.

36. A non-transitory computer-readable medium comprising instructions for decoding media access control protocol data units (MPDUs) in a wireless transmission to reduce power consumption, the instructions, when executed by a processor within a first station, cause the processor to:
receive a multi-destination aggregated media access control protocol data unit (MD-AMPDU) from an access point via an Institute of Electrical and Electronics Engineers (IEEE) 802.11 wireless network, the MD-AMPDU comprising a first set of one or more MPDUs having a first receive address associated with the first station and a second set of one or more MPDUs having a second receive address associated with a second station, the first set of one or more MPDUs grouped together in the MD-AMPDU and the second set of one or more MPDUs grouped together in the MD-AMPDU; and
enter the first station into a low-power mode after decoding the first set of one or more MPDUs.

37. The non-transitory computer-readable medium of claim 36, wherein the MD-AMPDU is transmitted according to an IEEE 802.11 standard.

38. The non-transitory computer-readable medium of claim 36, wherein the instructions are further executable to cause the processor to:
decode, at the first station, the first set of one or more MPDUs; and
detect, at the first station, an MPDU of the second set of one or more MPDUs after decoding the first set of one or more MPDUs, wherein the first station enters the low-power mode in response to detecting the MPDU of the second set of one or more MPDUs.

39. A first station for decoding media access control protocol data units (MPDUs), the first station comprising:
means for receiving a multi-destination aggregated media access control protocol data unit (MD-AMPDU) from an access point via an Institute of Electrical and Electronics Engineers (IEEE) 802.11 wireless network, the MD-AMPDU comprising a first set of one or more MPDUs having a first receive address associated with the first station and a second set of one or more MPDUs having a second receive address associated with a second station, the first set of one or more MPDUs grouped together in the MD-AMPDU and the second set of one or more MPDUs grouped together in the MD-AMPDU; and
means for entering the first station into a low-power mode after decoding the first set of one or more MPDUs.

40. The first station of claim 39, wherein the MD-AMPDU is transmitted according to an IEEE 802.11 standard.

41. A method for grouping media access control protocol data units (MPDUs) in wireless transmissions to reduce transmission times, the method comprising:
determining, at an access point, a first transmission time for transmitting a first physical layer protocol data unit (PPDU) to a first station at a first data rate, the first PPDU including a first set of one or more MPDUs addressed to the first station;
determining, at the access point, a second transmission time for transmitting a second PPDU to a second station at a second data rate, the second PPDU including a second set of one or more MPDUs addressed to the second station, the first data rate greater than the second data rate;
determining, at the access station, a third transmission time for transmitting a third PPDU to the first station and to the second station at the second data rate, the third PPDU including the first set of one or more MPDUs and the second set of one or more MPDUs; and
transmitting the third PPDU from the access point to the first station and to the second station at the second data rate if the third transmission time is less than a sum of the first transmission time and the second transmission time.

42. The method of claim 41, further comprising:
determining, at the access point, a fourth transmission time for transmitting a fourth PPDU to a third station at a third data rate, the fourth PPDU including a third set of one or more MPDUs addressed to the third station, the second data rate greater than the third data rate;
determining, at the access point, a fifth transmission time for transmitting a fifth PPDU to the first station, to the second station, and to the third station at the third data rate, wherein the fifth PPDU includes the first set of one or more MPDUs, the second set of one or more MPDUs, and the third set of one or more MPDUs; and
transmitting the fifth PPDU from the access point to the first station, to the second station, and to the third station if:
the fifth transmission time is less than a sum of the first transmission time, the second transmission time, and the fourth transmission time; and
the fifth transmission time is less than a sum of the third transmission time and the fourth transmission time.

43. The method of claim 41, further comprising grouping the first set of one or more MPDUs and the second set of one or more MPDUs into a multi-destination aggregated media access control protocol data unit (MD-AMPDU), wherein the third PPDU includes the MD-AMPDU.

44. The method of claim 41, wherein the third PPDU is transmitted to the first station and to the second station via an Institute of Electrical and Electronics Engineers (IEEE) 802.11 wireless network.

45. The method of claim 44, wherein the third PPDU is transmitted according to an IEEE 802.11 standard.

46. An access point for grouping media access control protocol data units (MPDUs), the access point comprising:
a processor; and
a memory storing instructions executable by the processor to perform operations comprising:
determining a first transmission time for transmitting a first physical layer protocol data unit (PPDU) to a first station at a first data rate, the first PPDU including a first set of one or more MPDUs addressed to the first station;
determining a second transmission time for transmitting a second PPDU to a second station at a second data rate, the second PPDU including a second set of one or more MPDUs addressed to the second station, the first data rate greater than the second data rate;
determining a third transmission time for transmitting a third PPDU to the first station and to the second station at the second data rate, the third PPDU including the first set of one or more MPDUs and the second set of one or more MPDUs; and
initiating transmission of the third PPDU from the access point to the first station and to the second station at the second data rate if the third transmission time is less than a sum of the first transmission time and the second transmission time.

47. The access point of claim 46, wherein the operations further comprise:
determining, at the access point, a fourth transmission time for transmitting a fourth PPDU to a third station at a third data rate, the fourth PPDU including a third set of one or more MPDUs addressed to the third station, the second data rate greater than the third data rate;
determining, at the access point, a fifth transmission time for transmitting a fifth PPDU to the first station, to the second station, and to the third station at the third data rate, wherein the fifth PPDU includes the first set of one or more MPDUs, the second set of one or more MPDUs, and the third set of one or more MPDUs; and
initiating transmission of the fifth PPDU from the access point to the first station, to the second station, and to the third station if:
the fifth transmission time is less than a sum of the first transmission time, the second transmission time, and the fourth transmission time; and
the fifth transmission time is less than a sum of the third transmission time and the fourth transmission time.

48. The access point of claim 46, wherein the operations further comprise grouping the first set of one or more MPDUs and the second set of one or more MPDUs into a multi-destination aggregated media access control protocol data unit (MD-AMPDU), wherein the third PPDU includes the MD-AMPDU.

49. The access point of claim 46, wherein the third PPDU is transmitted to the first station and to the second station via an Institute of Electrical and Electronics Engineers (IEEE) 802.11 wireless network.

50. The access point of claim 49, wherein the third PPDU is transmitted according to an IEEE 802.11 standard.

51. A non-transitory computer-readable medium comprising instructions for grouping media access control protocol data units (MPDUs) in wireless transmissions to reduce transmission times, the instructions, when executed by a processor within an access point, cause the processor to:
determine a first transmission time for transmitting a first physical layer protocol data unit (PPDU) to a first station at a first data rate, the first PPDU including a first set of one or more MPDUs addressed to the first station;
determine a second transmission time for transmitting a second PPDU to a second station at a second data rate, the second PPDU including a second set of one or more MPDUs addressed to the second station, the first data rate greater than the second data rate;
determine a third transmission time for transmitting a third PPDU to the first station and to the second station at the second data rate, the third PPDU including the first set of one or more MPDUs and the second set of one or more MPDUs; and
initiate transmission of the third PPDU from the access point to the first station and to the second station at the second data rate if the third transmission time is less than a sum of the first transmission time and the second transmission time.

52. The non-transitory computer-readable medium of claim 51, wherein the instructions are further executable to cause the processor to:
determine a fourth transmission time for transmitting a fourth PPDU to a third station at a third data rate, the fourth PPDU including a third set of one or more MPDUs addressed to the third station, the second data rate greater than the third data rate;
determine a fifth transmission time for transmitting a fifth PPDU to the first station, to the second station, and to the third station at the third data rate, wherein the fifth PPDU includes the first set of one or more MPDUs, the second set of one or more MPDUs, and the third set of one or more MPDUs; and
initiate transmission of the fifth PPDU from the access point to the first station, to the second station, and to the third station if:
the fifth transmission time is less than a sum of the first transmission time, the second transmission time, and the fourth transmission time; and
the fifth transmission time is less than a sum of the third transmission time and the fourth transmission time.

53. The non-transitory computer-readable medium of claim 51, wherein the instructions are further executable to cause the processor to group the first set of one or more MPDUs and the second set of one or more MPDUs into a multi-destination aggregated media access control protocol data unit (MD-AMPDU), wherein the third PPDU includes the MD-AMPDU.

54. The non-transitory computer-readable medium of claim 51, wherein the third PPDU is transmitted to the first station and to the second station via an Institute of Electrical and Electronics Engineers (IEEE) 802.11 wireless network.

55. The non-transitory computer-readable medium of claim 51, wherein the third PPDU is transmitted according to an IEEE 802.11 standard.

56. An access point for grouping media access control protocol data units (MPDUs), the access point comprising:
means for determining a first transmission time for transmitting a first physical layer protocol data unit (PPDU) to a first station at a first data rate, the first PPDU including a first set of one or more MPDUs addressed to the first station;
means for determining a second transmission time for transmitting a second PPDU to a second station at a second data rate, the second PPDU including a second set of one or more MPDUs addressed to the second station, the first data rate greater than the second data rate;
means for determining a third transmission time for transmitting a third PPDU to the first station and to the second station at the second data rate, the third PPDU including the first set of one or more MPDUs and the second set of one or more MPDUs; and
means for transmitting the third PPDU from the access point to the first station and to the second station at the second data rate if the third transmission time is less than a sum of the first transmission time and the second transmission time.

57. The access point of claim 56, wherein the third PPDU is transmitted to the first station and to the second station via an Institute of Electrical and Electronics Engineers (IEEE) 802.11 wireless network.

58. The access point of claim 57, wherein the third PPDU is transmitted according to an IEEE 802.11 standard.

59. A method for assigning stations to different frequency bands in a multi-band physical layer protocol data unit (PPDU) to reduce a length of the multi-band PPDU, the method comprising:
determining, at an access point, whether at least one station is assigned to each frequency band in the multi-band PPDU;
in response to a determination that at least one station is assigned to each frequency band,
identifying a principal frequency band, the principal frequency band having a longer length than other frequency bands;
grouping first media access control protocol data units (MPDUs) in a first non-principal frequency band and second MPDUs in a second non-principal frequency band into the first non-principal frequency band, the first MPDUs addressed to a first station and the second MPDUs addressed to a second station;
determining whether a length of the first non-principal frequency band is longer than a length of the principal frequency band; and
assigning the first station to the first non-principal frequency band and the second station to the second non-principal frequency band if the length of the first non-principal frequency band is longer than the length of the principal frequency band; and
in response to a determination that at least one station is not assigned to each frequency band, assigning a third station previously assigned to the principal frequency band to an empty frequency band.

60. The method of claim 59, wherein the length of the principal frequency band is based on a data rate of the principal frequency band and a data size of MPDUs in the principal frequency band.

61. The method of claim 59, wherein the principal frequency band has a first data rate, the first non-principal frequency band has a second data rate, and the second non-principal frequency band has a third data rate.

62. An access point for assigning stations to different frequency bands in a multi-band physical layer protocol data unit (PPDU) to reduce a length of the multi-band PPDU, the access point comprising:
a processor; and
a memory storing instructions executable by the processor to perform operations comprising:
determining whether at least one station is assigned to each frequency band in a multi-band PPDU;
in response to a determination that at least one station is assigned to each frequency band,
identifying a principal frequency band, the principal frequency band having a longer length than other frequency bands;
grouping first media access control protocol data units (MPDUs) in a first non-principal frequency band and second MPDUs in a second non-principal frequency band into the first non-principal frequency band, the first MPDUs addressed to a first station and the second MPDUs addressed to a second station;
determining whether a length of the first non-principal frequency band is longer than a length of the principal frequency band; and
assigning the first station to the first non-principal frequency band and the second station to the second non-principal frequency band if the length of the first non-principal frequency band is longer than the length of the principal frequency band; and
in response to a determination that at least one station is not assigned to each frequency band, assigning a third station previously assigned to the principal frequency band to an empty frequency band.

63. The access point of claim 62, wherein the length of the principal frequency band is based on a data rate of the principal frequency band and a data size of MPDUs in the principal frequency band.

64. The access point of claim 62, wherein the principal frequency band has a first data rate, the first non-principal frequency band has a second data rate, and the second non-principal frequency band has a third data rate.

65. A non-transitory computer-readable medium comprising instructions for assigning stations to different frequency bands in a multi-band physical layer protocol data unit (PPDU) to reduce a length of the multi-band PPDU the instructions, when executed by a processor within an access point, cause the processor to:
determine whether at least one station is assigned to each frequency band in the multi-band PPDU;
in response to a determination that at least one station is assigned to each frequency band,
identify a principal frequency band, the principal frequency band having a longer length than other frequency bands;
group first media access control protocol data units (MPDUs) in a first non-principal frequency band and second MPDUs in a second non-principal frequency band into the first non-principal frequency band, the first MPDUs addressed to a first station and the second MPDUs addressed to a second station;
determine whether a length of the first non-principal frequency band is longer than a length of the principal frequency band; and
assign the first station to the first non-principal frequency band and the second station to the second non-principal frequency band if the length of the first non-principal frequency band is longer than the length of the principal frequency band; and
in response to a determination that at least one station is not assigned to each frequency band, assign a third station previously assigned to the principal frequency band to an empty frequency band.

66. The non-transitory computer-readable medium of claim 65, wherein the length of the principal frequency band is based on a data rate of the principal frequency band and a data size of MPDUs in the principal frequency band.

67. The non-transitory computer-readable medium of claim 65, wherein the principal frequency band has a first data rate, the first non-principal frequency band has a second data rate, and the second non-principal frequency band has a third data rate.
